(19) United States
(12) Patent Application Publication
(10) Pub. No.: US 2018/0040448 A1
(43) Pub. Date: Feb. 8, 2018

(54) FUSE POSITIONING FIXTURE

(71) Applicant: VOLVO TRUCK CORPORATION, Göteborg (SE)

(72) Inventors: Steven Abraham THACKER, Fairlawn, VA (US); Paul Edward KINSER, Jr., Bluefield, WV (US); Sheldon Keith OUSLEY, Hillsville, VA (US)

(73) Assignee: VOLVO TRUCK CORPORATION, Göteborg (SE)

(21) Appl. No.: 15/553,670

(22) PCT Filed: Feb. 27, 2015
(86) PCT No.: PCT/US15/18031

§ 371 Date: Aug. 25, 2017

(51) Int. Cl. H01H 85/02; H01H 85/22; H01H 85/20

(52) U.S. Cl. CPC H01H 85/0208; H01H 85/2045; H01H 85/22

(57) ABSTRACT

A fuse positioning fixture includes a fuse positioning template and a fuse loading block. The fuse positioning template includes a number of fuse positioning openings. Each one of the fuse positioning openings extends through the fuse positioning template and corresponds with a fuse holder in a fuse relay center. The fuse positioning template includes solid portions adjacent each one of the fuse positioning openings which provide a fuse blocking portion. The fuse loading block includes a number of fuse loading openings and is configured to slidably engage with a top surface of the fuse positioning template such that in a first position of the fuse loading block fuses placed in the fuse loading openings are held in place by the fuse blocking portion. In a second position of the fuse loading block, the fuse loading openings align with the fuse positioning openings.

### FIELD OF THE DISCLOSURE

The present disclosure relates to a fuse positioning fixture configured to expedite the placement of fuses in a fuse relay center of a truck.

### BACKGROUND

Trucks often include a fuse relay center, which houses in a single device a number of fuses used by various circuits in the electrical system of the vehicle. In an effort to avoid the expense associated with designing a custom fuse relay center for different trucks or different truck models, a common fuse relay center may be used across several product lines. A fuse relay center may be designed to include fuse holders for circuits specific to particular truck models in addition to fuse holders for the circuits common to all the truck models. In conventional practice, the necessary fuses for a particular truck or truck model, common and specific, are placed in the fuse relay center by hand, according to instructions provided to a technician working on an assembly line. While generally effective, such a process is often arduous and time consuming. Further, such a process is prone to technician error, which may add delay and/or cost to the production of the truck.

Accordingly, there is a need for an apparatus and method for placing fuses into a fuse relay center that is efficient and accurate, saving both time and expense associated with the production of a truck.

### SUMMARY

The present disclosure relates to a fuse positioning fixture configured to expedite the placement of fuses in a fuse relay center. In one embodiment, a fuse positioning fixture includes a fuse positioning template and a fuse loading block. The fuse positioning template is a plate shaped element that provides an interface to the relay center and includes a bottom surface configured to securely sit on top of a fuse relay center. The fuse positioning template includes a number of fuse positioning openings corresponding to the fuse holder positions in the fuse relay center. Each of the fuse positioning openings extends through the fuse positioning template (i.e., is open on both a top surface and a bottom surface of the template) and aligns with a corresponding fuse holder in the fuse relay center when the fuse positioning template is placed on the fuse relay center. The solid portion of the fuse positioning template between the fuse positioning openings provides a fuse blocking portion as described below. The fuse loading block mounts for sliding on an upper surface of the fuse positioning template. The fuse loading block includes a number of fuse loading openings, which each extend through the fuse loading block and correspond with a different one of the fuse positioning openings. The fuse loading block is configured to slidably engage with a top surface of the fuse positioning template to be movable between a first position and a second position. In the first position, each of the fuse loading openings aligns with the fuse blocking portion of the fuse positioning template such that fuses placed in the fuse loading openings are held there by the fuse blocking portion. In the second position, each of the fuse loading openings aligns with a different one of the fuse positioning openings such that fuses located in the fuse loading openings may be delivered through the fuse positioning openings to a fuse holder in the fuse relay center. By allowing fuses to be placed into and held in the fuse loading block before dropping them into a fuse holder in the fuse relay center, technicians may more accurately and efficiently provide fuses into a fuse relay center. Accordingly, this portion of a truck manufacture process may be improved, thereby saving both time and expense.

In one embodiment, the fuse loading block is biased in the first position by a biasing mechanism. The biasing mechanism may be a biasing spring. In one embodiment, the biasing spring acts between a surface of a biasing spring guide channel in the fuse positioning template and a biasing post formed on the fuse loading block.

In one embodiment, the fuse positioning template includes a number of fastener holders extending from the top surface thereof. The fuse loading block may include an equal number of elongated apertures. The elongated apertures of the fuse loading block accept the fastener holders of the fuse positioning template, such that the fastener holders are permitted to slide relative to the elongated apertures. The apertures may be elongated either along a longitudinal axis of the fuse positioning fixture or a lateral axis of the fuse positioning fixture, thereby allowing the fuse loading block to move along the longitudinal axis or the lateral axis, respectively. In one embodiment, fasteners engage the fastener holders to secure the fuse loading block with the fuse positioning template while allowing for sliding movement.

In one embodiment, the bottom surface of the fuse positioning template includes a number of alignment recesses, which are configured to accept a different alignment notch extending from the fuse relay center. In one embodiment, the alignment recesses of the fuse positioning template only accept the alignment notches of the fuse relay center in a single orientation. Accordingly, correctly placing the fuse positioning fixture on top of the fuse relay center may easily be accomplished and verified.

In one embodiment, a top surface of the fuse loading block includes a number of fuse template pockets, which are each adjacent to a different one of the fuse loading openings. The fuse template pockets are configured to hold a template fuse to indicate the type of fuse to be placed in the adjacent fuse loading opening. In one embodiment, the template fuses are fuses with the conducting portion removed so that they may properly sit in the fuse template pockets. The template fuses allow a technician loading the fuse positioning fixture to easily see which fuses should be placed in which fuse loading openings, thereby further improving accuracy and efficiency of fuse placement into a fuse relay center.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 shows an exploded view of a fuse positioning fixture according to one embodiment of the present disclosure.

FIG. 2 shows an isomeric view of the fuse positioning fixture according to one embodiment of the present disclosure.

FIGS. 3A and 3B show top views of the fuse positioning fixture according to various embodiments of the present disclosure.

FIG. 4 shows a bottom view of a fuse loading block according to one embodiment of the present disclosure.

FIG. 5 shows a bottom view of the fuse loading block according to an additional embodiment of the present disclosure.

FIGS. 6A and 6B show a cross-sectional view of the fuse positioning fixture through the operation thereof according to one embodiment of the present disclosure.

FIGS. 7A and 7B show a cross-sectional view of the fuse positioning fixture through the operation thereof according to an additional embodiment of the present disclosure.

FIGS. 8A and 8B show a cross-sectional view of a fuse relay center according to one embodiment of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

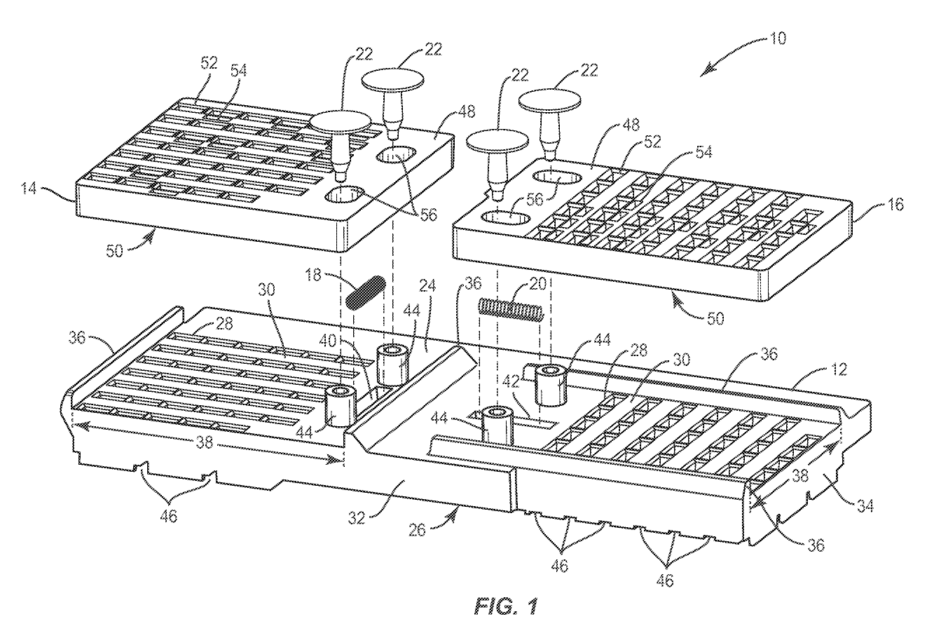

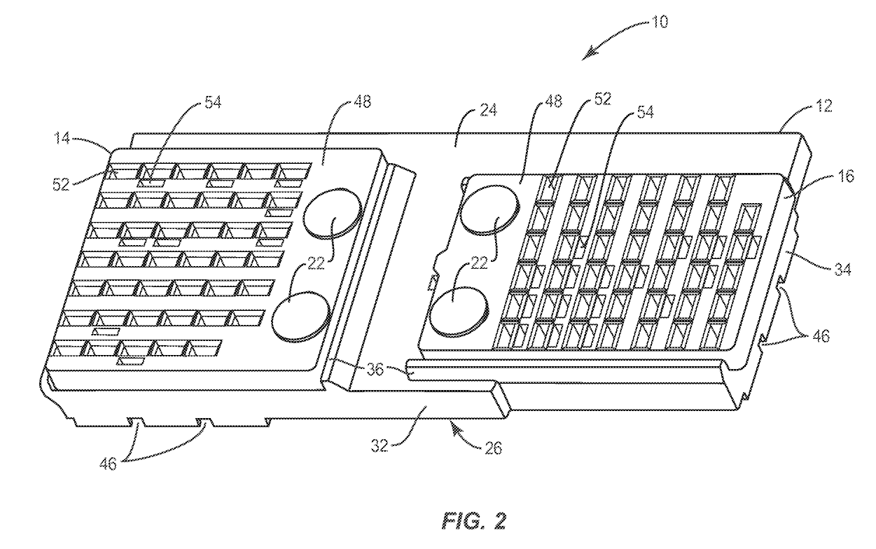

FIGS. 1 and 2 show a fuse positioning fixture 10 according to one embodiment of the present disclosure. FIG. 1 shows an exploded view of the fuse positioning fixture 10 while FIG. 2 shows an isometric view of the fuse positioning fixture 10. The fuse positioning fixture 10 includes a fuse positioning template 12, a first fuse loading block 14, a second fuse loading block 16, a first biasing spring 18, a second biasing spring 20, and a number of fasteners 22. The fuse positioning template 12 includes a top surface 24 and a bottom surface 26. The fuse positioning template 12 includes a number of fuse positioning openings 28, which extend from the top surface 24 through the fuse positioning template 12. The solid portions of the top surface 24 between the fuse positioning openings 28 provide a fuse blocking portion 30 as described below. The fuse positioning openings 28 are arranged in rows, which are separated by the fuse blocking portion 30.

In one embodiment illustrated in FIG. 1, the fuse positioning openings 28 are arranged in two groups, such that a first group of the fuse positioning openings 28 is oriented with the rows in a first direction that is parallel to a longitudinal surface 32 of the fuse positioning template 12 and a second group of the fuse positioning openings 28 is oriented with the rows parallel to a lateral surface 34 of the fuse positioning template 12. Those of ordinary skill in the art will appreciate the particular layout of the fuse positioning openings 28 required for a particular layout of fuse holders in a fuse relay center.

The fuse loading blocks 14, 16 are positioned on the top surface 24 for sliding movement thereon. The top surface 24 of the fuse positioning template 12 includes fuse loading block guides 36, which are ridges formed on the top surface and positioned to abut opposite lateral surfaces of one of the first fuse loading block 14 or the second fuse loading block 16 when the fuse positioning fixture 10 is assembled. The fuse loading block guides 36 define a fuse loading block channel 38 that limits the sliding movement of the particular fuse loading block 14, 16 along a single direction.

A first biasing spring guide channel 40 and a second biasing spring guide channel 42 are formed in the top surface 24 of the fuse positioning template 12 to hold the first biasing spring 18 and the second biasing spring 20, respectively. The biasing springs act on the fuse loading blocks 14, 16 to bias the loading blocks to a first position, as described below. While a biasing spring is shown as one exemplary biasing mechanism for the first fuse loading block 14 and the second fuse loading block 16, any suitable biasing mechanism capable of providing a sufficient force to hold the first fuse loading block 14 and the second fuse loading block 16 in the first position may be used without departing from the principles of the present disclosure.

A number of fastener holders 44 extend outward from the top surface 24 of the fuse positioning template 12 in the form of substantially circular posts.

The bottom surface 26 of the fuse positioning template 12 includes a number of alignment recesses 46, which engage alignment notches formed on the fuse relay center (not shown) to correctly orient the fuse positioning template 12 to be easily and securely on the fuse relay center. Generally, the alignment recesses 46 on the fuse positioning fixture 10 and the alignment notches on the fuse relay center are constructed such that the alignment recesses 46 align with the alignment notches in a single orientation, thereby ensuring that the fuse positioning fixture 10 is properly placed on the fuse relay center each time.

Each of the first fuse loading block 14 and the second fuse loading block 16 includes a top surface 48 and a bottom surface 50. Further, each of the first fuse loading block 14 and the second fuse loading block 16 includes a number of fuse loading openings 52 which extend through the respective fuse loading block and correspond to a different one of the fuse positioning openings 28. As shown in FIG. 1, the fuse loading openings 52 of the first fuse loading block 14 are oriented to be parallel to the longitudinal surface 32 of the fuse positioning template 12, while the fuse loading openings 52 of the second fuse loading block 16 are oriented to be parallel to the lateral surface 34 of the fuse positioning template 12. The particular arrangement and orientation of the fuse loading openings 52 will vary depending on the fuse positioning openings 28 of the fuse positioning template 12, which, as discussed above, vary depending on the particular layout of the fuse holders in a fuse relay center with which the fuse positioning fixture 10 is to be used.

The top surface 48 of the first fuse loading block 14 and the second fuse loading block 16 further includes a number of fuse template pockets 54, which extend into the top surface 48 but not through to the bottom surface 50. The fuse template pockets 54 are sized to hold a template fuse adjacent to a particular fuse loading opening 52 to indicate the type of fuse that should be placed in the associated fuse loading opening 52. The fuse template pockets 54 may be sized such that a fuse placed therein lies flush with the top surface 48, or so that a template fuse placed therein extends from the top surface 48 such that the template fuse is easily grasped for removal. Generally, the fuse template pockets 54 are placed adjacent to fuse loading openings 52 that require a fuse common to all the makes or models of trucks for which the fuse positioning fixture 10 is currently being used.

The top surface 48 of the first fuse loading block 14 and the second fuse loading block 16 further includes a pair of elongated apertures 56. The elongated apertures 56 each receive a fastener holder 44 when the fuse loading block is positioned on the fuse positioning template 12. Each elongated aperture 56 has a width that is approximately the same as the diameter of one of the fastener holders 44. The fastener holders 44 allow the fuse loading block to slide in a single direction and provide start and end points for movement. In one embodiment, the pair of elongated apertures 56 of the first fuse loading block 14 are oriented such that it is permitted to move parallel to the lateral surface 34 of the fuse positioning template 12, while the pair of elongated apertures 56 of the second fuse loading block 16 are oriented such that it is permitted to move parallel to the longitudinal surface 32 of the fuse positioning template 12. The fasteners 22 each extend through a different one of the elongated apertures 56 and into a different one of the fastener holders 44.

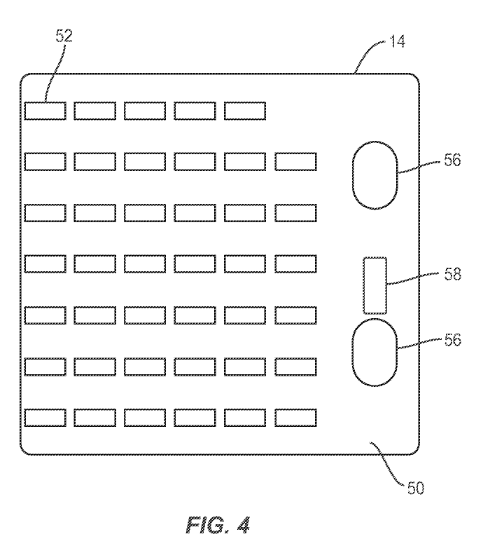

As shown in FIGS. 4, 5 and 6A, the bottom surface 50 of both the first fuse loading block 14 and the second fuse loading block 16 includes a biasing post 58 that extends outward from the bottom surface 50. The biasing post 58 is of a width and depth sufficient to extend into the first biasing spring guide channel 40 in the case of the first fuse loading block 14 and the second biasing spring guide channel 42 in the case of the second fuse loading block 16.

FIG. 4 shows a bottom view of the first fuse loading block 14 according to one embodiment of the present disclosure. As shown, the first fuse loading block 14 includes the fuse loading openings 52. Further, the first fuse loading block 14 includes the pair of elongated apertures 56 and the biasing post 58.

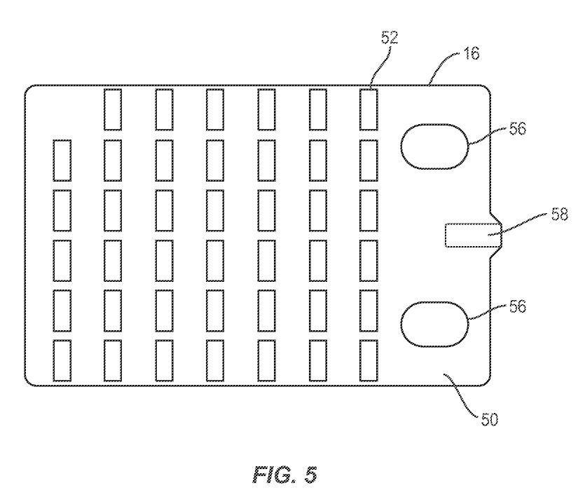

FIG. 5 shows a bottom view of the second fuse loading block 16 according to one embodiment of the present disclosure. As shown, the second fuse loading block 16 includes the fuse loading openings 52. Further, the second fuse loading block 16 includes the pair of elongated apertures 56 and the biasing post 58.

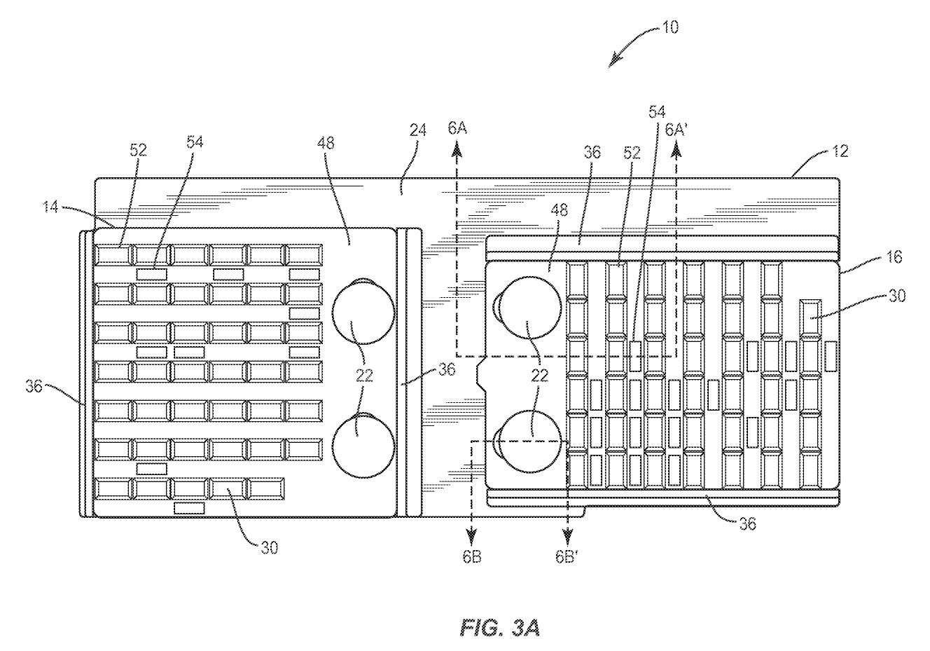

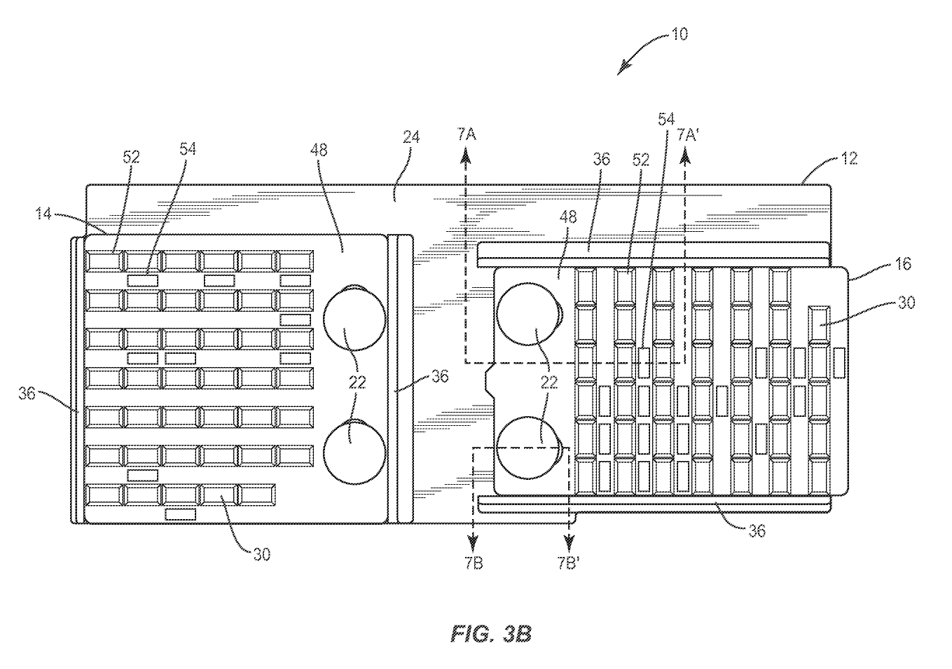

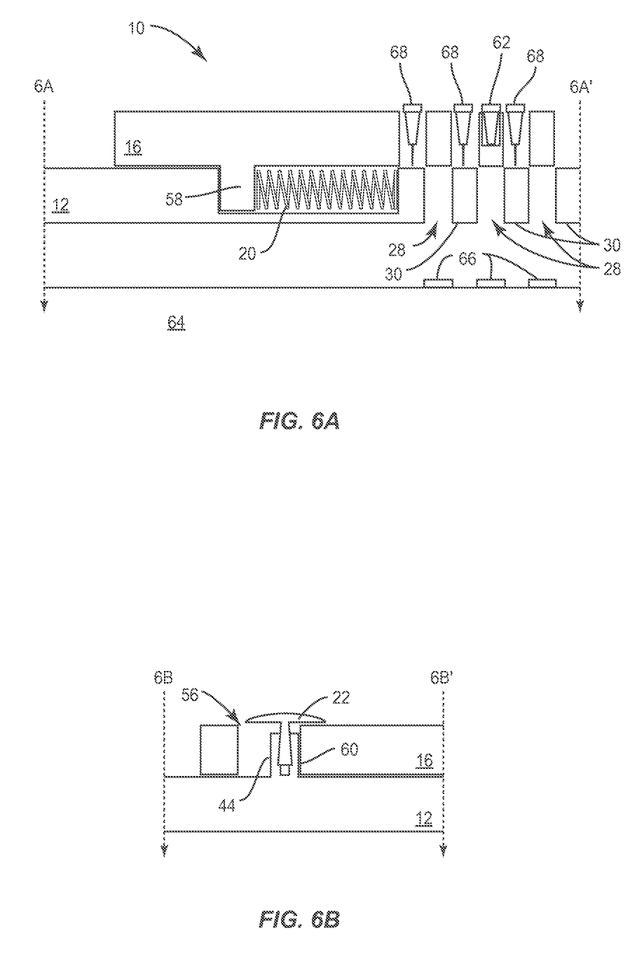

FIG. 3A shows a top view of the fuse positioning fixture 10 according to one embodiment of the present disclosure in which the first fuse loading block 14 and the second fuse loading block 16 are each in the first position discussed above. That is, the first fuse loading block 14 and the second fuse loading block 16 are each arranged such that the fuse loading openings 52 are aligned with a fuse blocking portion 30 of the fuse positioning template 12 such that fuses placed in the fuse loading openings 52 are held in the fuse loading openings 52 and not permitted to pass through the fuse positioning template 12. A first cross-section 6A-6A′ and a second cross-section 6B-6B′ are each indicated in FIG. 3A and detailed in FIGS. 6A and 6B.

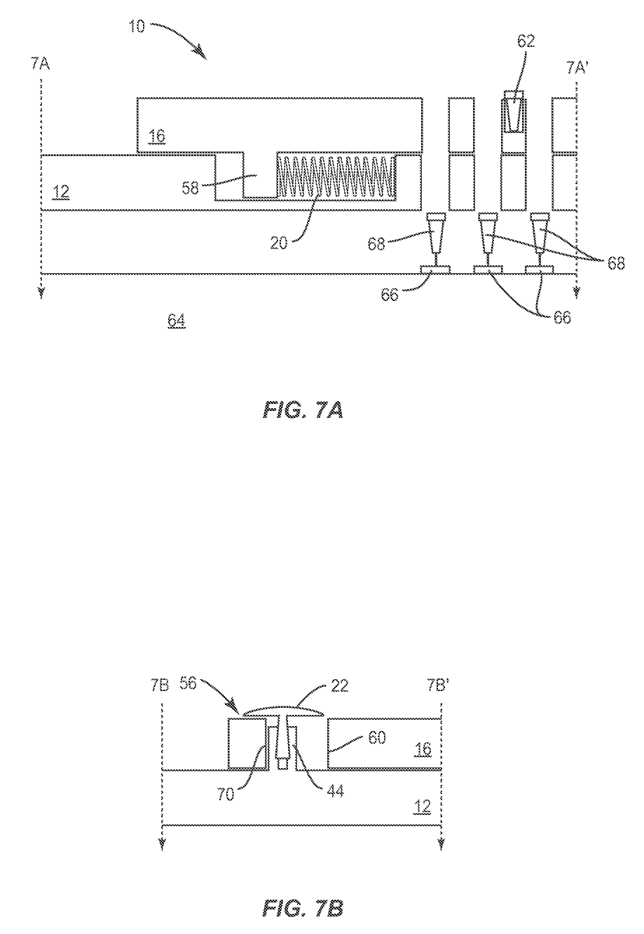

FIG. 3B shows a top view of the fuse positioning fixture 10 wherein the first fuse loading block 14 is left in the first position and a force is applied to the second fuse loading block 16 to move the second fuse loading block 16 into the second position discussed above. In the second position of the second fuse loading block 16, the fuse loading openings 52 therein align with the fuse positioning openings 28 in the fuse positioning template 12, thereby allowing fuses placed in the fuse loading openings 52 to fall through the fuse positioning openings 28 and into a fuse holder in a fuse relay center over which the fuse positioning fixture 10 is placed. A third cross-section 7A-7A′ and a fourth cross-section 7B-7B′ are each indicated in FIG. 3B and detailed in FIGS. 7A and 7B.

FIGS. 6A-B and 7A-B illustrate operational details of the fuse positioning fixture 10 according to one embodiment of the present disclosure. FIGS. 6A and 6B show cross-sections taken along lines 6A-6A′ and 6B-6B′ of FIG. 3A, respectively, which illustrate the fuse positioning template 12 and the second fuse loading block 16 when the second fuse loading block 16 is biased in the first position. While not shown, the details of operation of the first fuse loading block 14 are substantially similar to those discussed below with respect to the second fuse loading block 16 and will be readily understood by those of ordinary skill in the art. As shown in FIG. 6A, the second biasing spring 20 is positioned between the biasing post 58 of the second fuse loading block 16 and a surface of the second biasing spring guide channel 42 to apply a force such that the second fuse loading block 16 is held in the first position. In the first position of the second fuse loading block 16, the fuse loading openings 52 therein are aligned with the fuse blocking portion 30 of the fuse positioning template 12 to close the bottom ends of the fuse loading openings. Further, as seen in FIG. 6B, the fastener holders 44 of the fuse positioning template 12 abut a first surface 60 of the elongated apertures 56 in the second fuse loading block 16.

Continuing with FIG. 6A, a template fuse 62 is shown loaded in the fuse template pocket 54 of the second fuse loading block 16. Further, the fuse positioning fixture 10 is shown on top of a fuse relay center 64 including a number of fuse holders 66, and a number of fuses 68 are shown loaded into the fuse loading openings 52. The fuses 68 are each held in the fuse loading openings 52 by the fuse blocking portion 30 of the fuse positioning template 12 below each of the fuse loading openings 52. Notably, the fuse loading openings 52 are sized to vertically hold the fuses 68 in place while making it easy to verify that the fuses 68 have been correctly placed. Further, the fuse loading openings 52 are sized such that the fuses 68 placed therein are easy to remove and replace in the case of an incorrect placement. The fuses 68 may be placed in the fuse loading openings 52 by a technician as indicated by the template fuses 62 in one or more fuse template pockets 54 and/or by written or visual instructions provided to the technician.

FIGS. 7A and 7B show cross-sections taken along lines 7A-7A′ and 7B-7B′ of FIG. 3B, respectively, which illustrate the fuse positioning template 12 and the second fuse loading block 16 after the second fuse loading block 16 is moved into the second position for discharge of the loaded fuses 68. As shown in FIG. 7A, when force is applied to the second fuse loading block 16 in a direction to counteract the force provided by the second biasing spring 20, the second biasing spring 20 compresses, thereby allowing the second fuse loading block 16 to move to the second position where the fuse loading openings 52 align with the fuse positioning openings 28 of the fuse positioning template 12. The elongated portions of the elongated apertures 56 of the second fuse loading block 16 travel along the fastener holders 44 of the fuse positioning template 12 such that the fastener holders 44 abut a second surface 70 of the elongated apertures 56. In the second position, the fuses 68 drop through the fuse loading openings 52 and through the fuse positioning openings 28 into a respective one of the fuse holders 66 in the fuse relay center 64. The fuses 68 are held vertically in place by the fuse holders 66 in the fuse relay center 64, but are not yet fully seated. Generally, the second fuse loading block 16 will be moved into the second position by a technician upon placement of the fuses 68 and confirming that the fuses are correctly placed. Allowing a technician to first place the fuses 68 and then inspect the accuracy of their placement before dropping the fuses 68 into place significantly improves both the efficiency and accuracy of fuse placement by a technician.

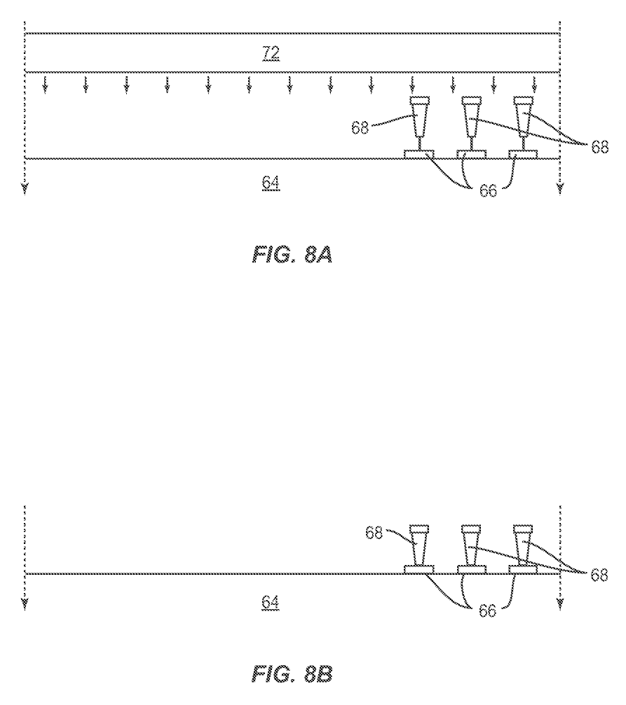

FIG. 8A shows the fuse relay center 64 after the fuse positioning fixture 10 has been removed therefrom. A seating tool 72 is placed on top of the fuses 68 and pressed downward to properly seat the fuses 68 into the fuse holders 66 of the fuse relay center 64. FIG. 8B shows the fuses 68 properly seated in the fuse holders 66 of the fuse relay center 64.

Using the fuse positioning fixture 10 to provide fuses into a fuse relay center greatly improves both the efficiency and accuracy of the task when compared to placing the fuses by hand. By using template fuses as visual indicators and allowing technicians to easily place and verify the fuses placed into the fuse positioning fixture 10 before choosing to drop the fuses into place, significant improvements can be made in this portion of the truck manufacturing process.

Those skilled in the art will recognize improvements and modifications to the preferred embodiments of the present disclosure. All such improvements and modifications are considered within the scope of the concepts disclosed herein and the claims that follow.

1. A fuse positioning device, comprising:
a fuse positioning template having a plurality of fuse positioning openings that each extend therethrough and are configured to align with a different fuse holder in a fuse relay center, and having solid portions adjacent the plurality of fuse positioning openings providing a fuse blocking portion of the fuse positioning template; and
a fuse loading block having a plurality of fuse loading openings that extend through the fuse loading block, wherein the fuse loading block is configured to engage with a top surface of the fuse positioning template for sliding movement between a first position and a second position, wherein
in the first position, each of the plurality of fuse loading openings is aligned with the fuse blocking portion of the fuse positioning template such that fuses loaded in the fuse loading openings are held in a respective fuse loading opening by the fuse blocking portion, and
in a second position, each of the plurality of fuse loading openings aligns with a different one of the fuse positioning openings such that the fuses located in the fuse loading openings may be delivered through the fuse positioning openings to fuse holders in the fuse relay center.

2. The fuse positioning fixture of claim 1, wherein the fuse loading block is biased in the first position by a biasing mechanism.

3. The fuse positioning fixture of claim 2, wherein the biasing mechanism is a biasing spring.

4. The fuse positioning fixture of claim 3, wherein the top surface of the fuse positioning template further comprises a biasing spring guide channel configured to accept the biasing spring.

5. The fuse positioning fixture of claim 4, wherein the fuse loading block includes a biasing post on a bottom surface thereof configured to extend into the biasing spring guide channel of the fuse positioning template.

6. The fuse positioning fixture of claim 1, wherein the fuse positioning template further comprises a plurality of fastener holders each formed as a substantially circular post that extends from the top surface of the fuse positioning template and the fuse loading block further comprises a plurality of elongated apertures extending through the fuse loading block to receive the fastener holders.

7. The fuse positioning fixture of claim 6, wherein the fuse positioning fixture further comprises a number of fasteners each configured to mate with a different one of the fastener holders such that the fuse loading block is slidably engaged with the fuse positioning template.

8. The fuse positioning fixture of claim 1, wherein a top surface of the fuse positioning template comprises a plurality of guides arranged to form a fuse loading block channel, the fuse loading block being positioned for sliding movement in the loading block channel.

9. The fuse positioning fixture of claim 1, comprising a second fuse loading block, wherein the fuse loading block is configured to slide along a lateral axis of the fuse positioning fixture and the second fuse loading block is configured to slide along a longitudinal axis of the fuse positioning fixture.

10. The fuse positioning fixture of claim 1, wherein a bottom surface of the fuse positioning template further comprises a plurality of alignment recesses configured to accept a different alignment notch from the fuse relay center.

11. The fuse positioning fixture of claim 1, wherein the fuse loading block further comprises a number of fuse template pockets, each positioned adjacent a different one of the fuse loading openings on a top surface of the fuse loading block and configured to hold a template fuse, the template fuse indicating a type of fuse to be placed in the adjacent fuse loading opening.

12. The fuse positioning fixture of claim 1, wherein the plurality of fuse positioning openings are arranged in rows, each of which is separated by the fuse blocking portion.
